(19) United States
(12) Patent Application Publication
(10) Pub. No.: US 2025/0200206 A1
(43) Pub. Date: Jun. 19, 2025

(54) DYNAMIC SENSITIVITY LABELS FOR DIGITAL FILES

(71) Applicant: DELL PRODUCTS L.P., Round Rock, TX (US)

(72) Inventors: Gandali Pradip Patil, San Antonio, TX (US); Fnu Jasleen, Austin, TX (US); Karunakar Palicherla Reddy, Austin, TX (US)

(73) Assignee: DELL PRODUCTS L.P., Round Rock, TX (US)

(21) Appl. No.: 18/544,643

(22) Filed: Dec. 19, 2023

(51) Int. Cl. G06F 21/62; G06F 16/16

(52) U.S. Cl. CPC G06F 21/6218; G06F 16/16

(57) ABSTRACT

Techniques for providing dynamic sensitivity labels for digital files are described. One example method includes identifying a digital file to which a sensitivity label is to be assigned; identifying context information associated with the digital file; and assigning a sensitivity label to the digital file based on content included in the digital file and the context information associated with the digital file.

### TECHNICAL FIELD

The present disclosure relates in general to information handling systems, and more particularly to techniques for providing dynamic sensitivity labels for digital files.

### BACKGROUND OF THE INVENTION

Generally, digital files stored in computer file systems are associated with a set of permissions controlling what users can access each file, and what level of access each user is allowed. These permissions are generally set manually by a user or to default permissions by the operating system or file system when a digital file is created. Generally, such default permissions are not based on the content of the digital file.

### SUMMARY OF THE INVENTION

In accordance with embodiments of the present disclosure, a method for providing dynamic sensitivity labels for digital files includes identifying a digital file to which a sensitivity label is to be assigned; identifying context information associated with the digital file; and assigning a sensitivity label to the digital file based on content included in the digital file and the context information associated with the digital file.

In some cases, identifying the context information associated with the digital file includes retrieving, by the computer system, portions of the context information from one or more endpoints over a network.

In some implementations, the context information includes a user that created the digital file, a creation date for the digital file, a list of users that worked on the digital file, and a list of users that the digital file was shared with.

In some cases, determining the sensitivity label is performed by a machine learning model trained to predict a sensitivity label for a digital file based on the content included in the digital file and the context information associated with the digital file.

In some implementations, the method further includes after assigning the sensitivity label, determining that the context information associated with digital file has changed; and in response, updating the sensitivity label for the digital file based on the changed context information associated with the digital file.

In some cases, the context information includes a product associated with the digital file, and a product release date, and the method further includes after assigning the sensitivity label, determining that the product release date has passed; and in response, updating the sensitivity label for the digital file based on updated context information indicating that the product release date associated with the digital file has passed.

In some cases, the method further includes receiving a request to access the digital file from a user associated with a user context; and in response, determining that the user is authorized to access the digital file based on the assigned sensitivity label and the user context.

In some implementations, the user context includes a user location in which the user is requesting the access the digital file.

In some cases, the digital file is one of an audio file, or a video file.

In some implementations, the digital file is one of a word processor file, a slideshow file, or a spreadsheet file.

In accordance with embodiments of the present disclosure, a system for providing dynamic sensitivity labels for digital files is configured to perform operations including identifying a digital file to which a sensitivity label is to be assigned; identifying context information associated with the digital file; and assigning a sensitivity label to the digital file based on content included in the digital file and the context information associated with the digital file.

In accordance with embodiments of the present disclosure, an article of manufacture includes a non-transitory, computer-readable medium having computer-executable instructions thereon that are executable by a processor of a computer system to perform operations for providing dynamic sensitivity labels for digital files including identifying a digital file to which a sensitivity label is to be assigned; identifying context information associated with the digital file; and assigning a sensitivity label to the digital file based on content included in the digital file and the context information associated with the digital file.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example system for providing dynamic sensitivity labels for digital files, in accordance with embodiments of the present disclosure;

FIG. 3 illustrates a flow chart of an example process for providing dynamic sensitivity labels for digital files, in accordance with embodiments of the present disclosure.

### DETAILED DESCRIPTION OF THE INVENTION

The present disclosure describes techniques for providing dynamic sensitivity labels for digital files with sensitive content. These dynamic sensitivity labels may be applied differently based on the context of the user attempting to access, such as, for example, taking into account a location in which the user is requesting access to the digital file, or a network from which the user is requesting access to the digital file. The sensitivity labels may also be dynamic in the manner in which they are applied to digital files and updated over time. A system, leveraging an appropriately trained machine learning (ML) (also referred to as artificial intelligence (AI)) model, may analyze the content of the digital file as well as a file context associated with the file in determining or recommending an appropriate sensitivity label for the file. As the relationship between the file context and outside factors changes, such as, for example, by the current date passing a date in the file context, the system may update the sensitivity label of the file based on such a change. The system may also update sensitivity labels for digital files when specific events related to a particular file occur, such as, for example, a user editing the content of the digital file. This updating enables the sensitivity labels to maintain relevance as time passes rather than becoming stale and outdated in the face of changing circumstances.

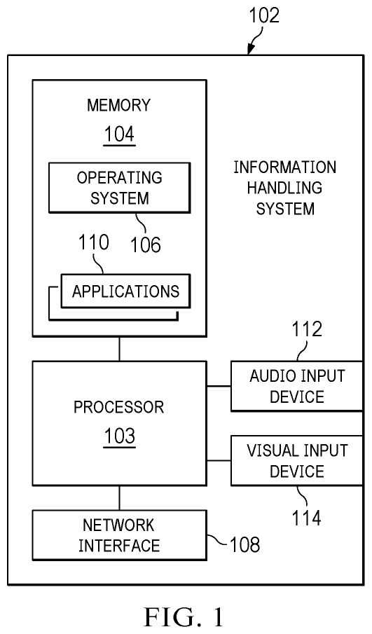

Preferred embodiments and their advantages are best understood by reference to FIGS. 1 through 3, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, and a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Memory 104 may also have stored thereon one or more applications 110. Each of the applications 110 may comprise any program of executable instructions (or aggregation of programs of executable instructions) configured to make use of the hardware resources of the information handling system 102, such as memory, processor time, disk space, input and output devices (e.g., 112, 114), and the like. In some implementations, the applications 110 may interact with the operating system 106 to make of the hardware resources, and the operating system 106 may manage and control the access of the applications 110 to these resources (as described above).

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In some embodiments, information handling system 102 may include more than one processor 103. For example, one such processor 103 may be a CPU, and other processors 103 may include various other processing cores such as application processing units (APUs) and graphics processing units (GPUS).

Information handling system 102 further includes an audio input device 112 communicatively coupled to processor 103. Audio input device 112 can be any device (e.g., a microphone) operable to detect audible signals (i.e., sound waves) in the environment external to the information handling system 102, and convert those audible signals into electrical signals. These electrical signals representing the detected audible signals can be provided to the processor 103 where they can be analyzed and interpreted, for example at the direction of applications 110 and/or operating system 106. In some cases, the audio input device 112 can be integrated into the information handling system 102, such as in the case of a built-in microphone. The audio input device 112 may also be an external device communicatively coupled to the information handling system 102, such as an external microphone connected via Universal Serial Bus (USB).

Information handling system 102 further includes an visual input device 114 communicatively coupled to processor 103. Visual input device 114 can be any device operable to detect electromagnetic radiation, such as visible light, and convert it into representative electrical signals. These electrical signals representing the detected electromagnetic radiation can be provided to the processor 103 where they can be analyzed and interpreted, for example at the direction of applications 110 and/or operating system 106. In some cases, the visual input device 114 can be complementary metal-oxide-semiconductor (CMOS) sensor, a charge coupled device (CCD) sensor, or another type of sensor operable to detect electromagnetic radiation. In some implementations, the visual input device 114 may be configured to detect a particular range of wavelengths of electromagnetic radiation, such as the visual light range, the ultraviolet range, the infrared range, or combinations of these and other ranges. In some cases, the visual input device 114 may be a low power camera device that monitors the environment while the information handling system 102 remains in a lower power state. In some implementations, the visual input device 114 can be integrated into the information handling system 102, such as in the case of a built-in camera. The visual input device 114 may also be an external device communicatively coupled to the information handling system 102, such as an external camera connected via USB.

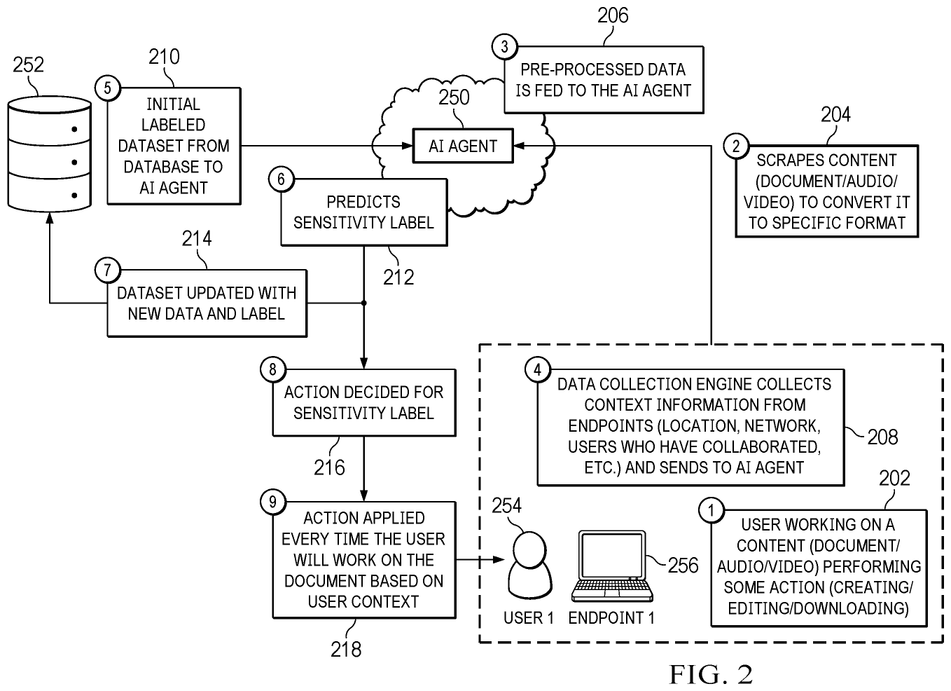

FIG. 2 illustrates a block diagram of an example system 200 for providing dynamic sensitivity labels for digital files, in accordance with embodiments of the present disclosure. FIG. 2 also depicts various actions performed by the components of the system 200, which will be described in turn.

As shown, the system 200 includes a user 254, an endpoint 256, an AI agent 250, and a database 252. The endpoint 256 may be a computer system such as the information handling system 102 described with respect to FIG. 1. The user 254 may be a user engaged with the endpoint 256 to perform tasks, such as editing content within a document. The AI agent 250 may include an AI model that has been trained to predict a desired sensitivity label for a digital file given the content of the digital file and a file context associated with the digital file as input. In some cases, the AI model may use a term frequency-inverse document frequency (TF-IDF) vectorization approach to identify related keywords in the content of the digital file, and a semi-supervised learning approach to recommend a sensitivity label. The model may also be implemented to use other appropriate learning and training techniques commonly used by such AI models.

The components of the system 200 may interact in a series of steps 202 through 218. The steps are numbered in FIG. 2 such that lower numbered steps occur first in the depicted example. At 202, the user 254 performs an action on a digital file using the endpoint 256, such as creating, editing, or downloading the digital file. At 204, a data collection engine (not shown), in response to the user's action with respect to the digital file, retrieves the digital file and converts its content into a specific format for use by the AI model. For example, if the digital file contains audio and/or video content, the data collection engine may produce a text representation of the content of the digital file. This step may be referred to as pre-processing. At 206, the pre-processed content data is provided as input to the AI agent 250.

At 208, the data collection engine collects context information associated with the digital file from endpoint 256, as well as from other endpoints that have information about the digital file. At 210, the database 252 provides an initial labeled dataset to the AI agent 250. At 212, the AI agent 250 predicts the appropriate sensitivity label for the digital file based on the initial labeled dataset, the pre-processed content of the digital file, and the context information. At 214, the AI agent 250 updates the database with the new labeled data set and the assigned label.

At 216, a set of actions is determined for the assigned sensitivity label. For example, the actions may include restricting users below a certain permission level from accessing the file until a certain date at which the content of the digital file will no longer be considered sensitive. At 218, the system 200 applies the determined action each time a user (e.g., 254) accesses the digital file.

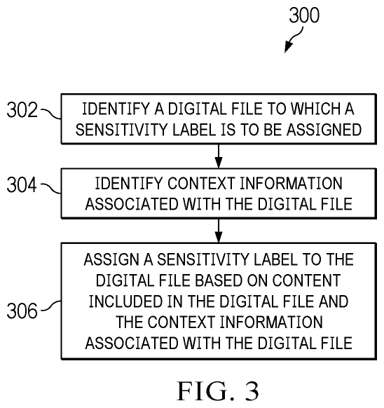

FIG. 3 illustrates a flow chart of an example process 300 for providing dynamic sensitivity labels for digital files, in accordance with embodiments of the present disclosure. At 302, a digital file to which a sensitivity label is to be assigned is identified. At 304, context information associated with the digital file is identified. At 306, a sensitivity label is assigned to the digital file based on content included in the digital file and the context information associated with the digital file.

In some cases, identifying the context information associated with the digital file includes retrieving, by the computer system, portions of the context information from one or more endpoints over a network.

In some implementations, the context information includes a user that created the digital file, a creation date for the digital file, a list of users that worked on the digital file, and a list of users that the digital file was shared with.

In some cases, determining the sensitivity label is performed by a machine learning model trained to predict a sensitivity label for a digital file based on the content included in the digital file and the context information associated with the digital file.

In some implementations, the process 300 further includes after assigning the sensitivity label, determining that the context information associated with digital file has changed; and in response, updating the sensitivity label for the digital file based on the changed context information associated with the digital file.

In some cases, the context information includes a product associated with the digital file, and a product release date, and the process 300 further includes after assigning the sensitivity label, determining that the product release date has passed; and in response, updating the sensitivity label for the digital file based on updated context information indicating that the product release date associated with the digital file has passed.

In some cases, the process 300 further includes receiving a request to access the digital file from a user associated with a user context; and in response, determining that the user is authorized to access the digital file based on the assigned sensitivity label and the user context.

In some implementations, the user context includes a user location in which the user is requesting the access the digital file.

In some cases, the digital file is one of an audio file, or a video file.

In some implementations, the digital file is one of a word processor file, a slideshow file, or a spreadsheet file.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or: indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for providing dynamic sensitivity labels for digital files, the method comprising:
identifying, by a computer system including at least one processor, a digital file to which a sensitivity label is to be assigned;
identifying, by the computer system, context information associated with the digital file; and
assigning, by the computer system, a sensitivity label to the digital file based on content included in the digital file and the context information associated with the digital file.

2. The method of claim 1, wherein identifying the context the digital file includes information associated with retrieving, by the computer system, portions of the context information from one or more endpoints over a network.

3. The method of claim 1, wherein the context information includes a user that created the digital file, a creation date for the digital file, a list of users that worked on the digital file, and a list of users that the digital file was shared with.

4. The method of claim 1, wherein determining the sensitivity label is performed by a machine learning model trained to predict a sensitivity label for a digital file based on the content included in the digital file and the context information associated with the digital file.

5. The method of claim 1, further comprising:
after assigning the sensitivity label, determining, by the computer system, that the context information associated with digital file has changed; and
in response, updating, by the computer system, the sensitivity label for the digital file based on the changed context information associated with the digital file.

6. The method of claim 1, wherein the context information includes a product associated with the digital file, and a product release date, the method further comprising:
after assigning the sensitivity label, determining, by the computer system, that the product release date has passed; and
in response, updating, by the computer system, the sensitivity label for the digital file based on updated context information indicating that the product release date associated with the digital file has passed.

7. The method of claim 1, further comprising:
receiving, by the computer system, a request to access the digital file from a user associated with a user context; and
in response, determining, by the computer system, that the user is authorized to access the digital file based on the assigned sensitivity label and the user context.

8. The method of claim 7, wherein the user context includes a user location in which the user is requesting the access the digital file.

9. The method of claim 1, wherein the digital file is one of an audio file, or a video file.

10. The method of claim 1, wherein the digital file is one of a word processor file, a slideshow file, or a spreadsheet file.

11. A system for providing dynamic sensitivity labels for digital files comprising:
a computer system including at least one processor and a memory, and configured to perform operations including:
identifying a digital file to which a sensitivity label is to be assigned;
identifying context information associated with the digital file; and
assigning a sensitivity label to the digital file based on content included in the digital file and the context information associated with the digital file.

12. The system of claim 11, wherein identifying the context information associated with the digital file includes retrieving, by the computer system, portions of the context information from one or more endpoints over a network.

13. The system of claim 11, wherein the context information includes a user that created the digital file, a creation date for the digital file, a list of users that worked on the digital file, and a list of users that the digital file was shared with.

14. The system of claim 11, wherein determining the sensitivity label is performed by a machine learning model trained to predict a sensitivity label for a digital file based on the content included in the digital file and the context information associated with the digital file.

15. The system of claim 11, further comprising:
after assigning the sensitivity label, determining that the context information associated with digital file has changed; and
in response, updating the sensitivity label for the digital file based on the changed context information associated with the digital file.

16. The system of claim 11, wherein the context information includes a product associated with the digital file, and a product release date, the system further comprising:
after assigning the sensitivity label, determining that the product release date has passed; and
in response, updating the sensitivity label for the digital file based on updated context information indicating that the product release date associated with the digital file has passed.

17. The system of claim 11, further comprising:
receiving a request to access the digital file from a user associated with a user context; and
in response, determining that the user is authorized to access the digital file based on the assigned sensitivity label and the user context.

18. The system of claim 17, wherein the user context includes a user location in which the user is requesting the access the digital file.

19. The system of claim 11, wherein the digital file is one of an audio file, or a video file.

20. An article of manufacture comprising a non-transitory, computer-readable medium having computer-executable instructions thereon that are executable by a processor of a computer system to perform operations for providing dynamic sensitivity labels for digital files, the operations comprising:
identifying a digital file to which a sensitivity label is to be assigned;
identifying context information associated with the digital file; and
assigning a sensitivity label to the digital file based on content included in the digital file and the context information associated with the digital file.
